(19) United States
(12) Patent Application Publication
(10) Pub. No.: US 2008/0251539 A1
(43) Pub. Date: Oct. 16, 2008

(54) Wristband-Mounted Dispenser for Liquids or Powders

(76) Inventors: John Yapaola, Kinnelon, NJ (US); David Conroy, Brooklyn, NY (US)

Correspondence Address: GORDON E NELSON;PATENT ATTORNEY, PC, 57 CENTRAL ST, PO BOX 782, ROWLEY, MA, 01969, US

(21) Appl. No.: 12/066,543

(22) PCT Filed: Sep. 14, 2006
(86) PCT No.: PCT/US06/35681

§ 371 Date: Mar. 12, 2008

Related U.S. Application Data
(60) Provisional application No. 60/717,507, filed on Sep. 15, 2005.
(60) Provisional application No. 60/811,008, filed on Jun. 5, 2006.

(51) Int. Cl. B67D 5/64

(52) U.S. Cl. 222/175

(57) ABSTRACT

A bracelet to be worn on the wrist which includes a dispenser for dispensing liquid or powdered materials such as sunblocks or germicides. The dispenser on the palm side of the wrist and when the user presses an activator, the dispenser emits a portion of the material onto the user's palm. The dispenser is approximately the size of a wrist watch. A preferred embodiment of the dispenser employs a pump which will work at any orientation. The pump uses air pressure differences produced by the movement of a piston to pull the material into a chamber and expel it from the chamber through a one-way valve. The one-way valve in a preferred embodiment of the pump is made from a silicon diaphragm which opens when it flexes in response to pressure differences and a support for the diaphragm which permits it to flex in only one direction.

### CROSS-REFERENCE TO RELATED APPLICATIONS

This patent application claims priority from U.S. provisional patent application 60/717,507, John Yapaola, Wrist-mounted dispenser for hand-applied materials, filed Sep. 15, 2005, and 60/811,008, John Yapaola and David Conroy, Wristband-mounted topical lotion/liquid dispenser, filed Jun. 5, 2006. Each of these provisional patent applications is incorporated by reference into the present patent application for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates to dispensers of liquids and powders and more particularly to such dispensers that dispense the liquid or powder in discrete amounts.

2. Description of Related Art

There are many situations in which it is desirable to frequently apply a topical lotion or powder by hand. One example is the application of lotions or germicidal solutions to the hands; another is the application of sunblock or suntan lotion; a third is the application of insect repellant. Frequent application is often made more difficult by the fact that the need to apply occurs in an environment such as work or the beach where it may be inconvenient to get to a bottle of the lotion or powder. A disclosure of one approach to solving the problem of having a solution or powder available when you need it could be found on Apr. 14, 2006 at www.wristbands.com.au/sun_screen_wristbands.htm. The sun screen wristband disclosed there is a tube containing 50 mL of sunscreen. The tube is closed with a cap and has the form of a bracelet that can be worn on the wrist or arm. To apply the sunscreen, one removes the bracelet from the arm and then applies sunscreen as one does from an ordinary tube of sunscreen: one opens the cap, uses one hand to squeeze the sunscreen out of the tube into the palm of the other hand, and then applies the sunscreen. While this approach is useful for applying sunscreen, which need be done only every two hours or so, it has a number of practical and aesthetic drawbacks:
The process of application, which involves removing the bracelet, opening the cap, and squeezing out the sunblock, is too time consuming for use with substances such as germicides, which must be applied at far more frequent intervals;
The bracelet has no mechanism for providing measured amounts of sunblock.
The bracelet is not refillable;
The bracelet is too bulky and conspicuous to be worn with ordinary white- or pink-collar work clothes.

What is needed is a wristband that dispenses a material, but is easier to use, provides measured amounts of the material, is refillable, and may be worn with ordinary white- or pink-collar work clothes. It is an object of the present invention to provide such a wristband.

### BRIEF SUMMARY OF THE INVENTION

The object of the invention is achieved by a bracelet that has attached to it a dispenser for dispensing a material. The dispenser has a space for the material, a nozzle, and an activator and responds to pressure of a finger on the activator by emitting a portion of the material in the space through the nozzle. Further aspects of the invention include the following:
the bracelet is worn on the wrist with the dispenser on the palm side of the wrist and the nozzle is situated on the dispenser such that the emitted material is directed towards the palm of the hand attached to the wrist.
the dispenser is aimable. One way of aiming the dispenser is by flexing the bracelet.
the space may be refilled with the material.
the material is contained in a container and the space is refilled by placing the container in the space.
The material may be a liquid or a powder and may have germicidal or sunblocking properties.
The dispenser comprises a pump that responds to the pressure of a finger on the activator by pumping material from the space through the nozzle. The pump is not affected by the orientation of the dispenser.
The dispenser is approximately the size of the watch in a wristwatch and the bracelet may additionally be used in any way in which a bracelet has been or will be used.

The pump used in a preferred embodiment of the dispenser has a piston that moves in a tube. The tube has an end and a first one-way valve in a wall of the tube. The one-way valve admits air to the tube but blocks air from escaping from the tube. The pump further has an air-tight chamber which is connected to the end of the tube and is capable of being connected by a second one-way valve to a source of the material. The second one-way valve opens only when the pressure in the chamber is lower than the pressure on the material in the source of material, The air-tight chamber is further connected to a third one-way valve that opens only when the pressure in the chamber is higher than the pressure on the other side of the valve. Operation of the pump when the source of material is connected to the chamber is as follows: when the piston is moved away from the end of the tube, the pressure in the chamber is decreased and as a result, a portion of the material moves from the source through the second one-way valve into the chamber until the piston passes the first one-way valve. When the piston is then moved back toward the end of the tube, the pressure in the tube is increased and as a result, material in the chamber moves through the third one-way valve.

In other aspects, the amount of material that moves from the source into the chamber depends on the position of the first one-way valve relative to the end of the tube and the amount by which the pressure in the chamber is increased depends on the distance between a start position for the piston in the tube and the end of the tube.

The pump of the preferred embodiment includes a one way valve that is made up of a flexible diaphragm and a support on one side of the diaphragm. The flexible diaphragm is situated between spaces that may be at different pressures. The diaphragm has an opening which is closed when the diaphragm is flat and which opens increasingly as the diaphragm flexes in response to a difference between the pressures. The support permits the diaphragm to flex towards one of the spaces but not towards the other.

### BRIEF DESCRIPTION OF THE SEVERAL VIEWS OF THE DRAWINGS

FIG. 1 is a view of one embodiment of a wristband with a dispenser for materials;

FIG. 2 is a set of detailed views of an embodiment of a dispenser that may be used in the wristband of FIG. 1;

FIG. 3 is a set of views of another embodiment of a dispenser that may be used with the wristband of FIG. 1;

FIG. 4 presents exploded and cross-sectional views of the dispenser of FIG. 3; and

FIG. 5 is a detailed view of a preferred embodiment of a one-way spit valve.

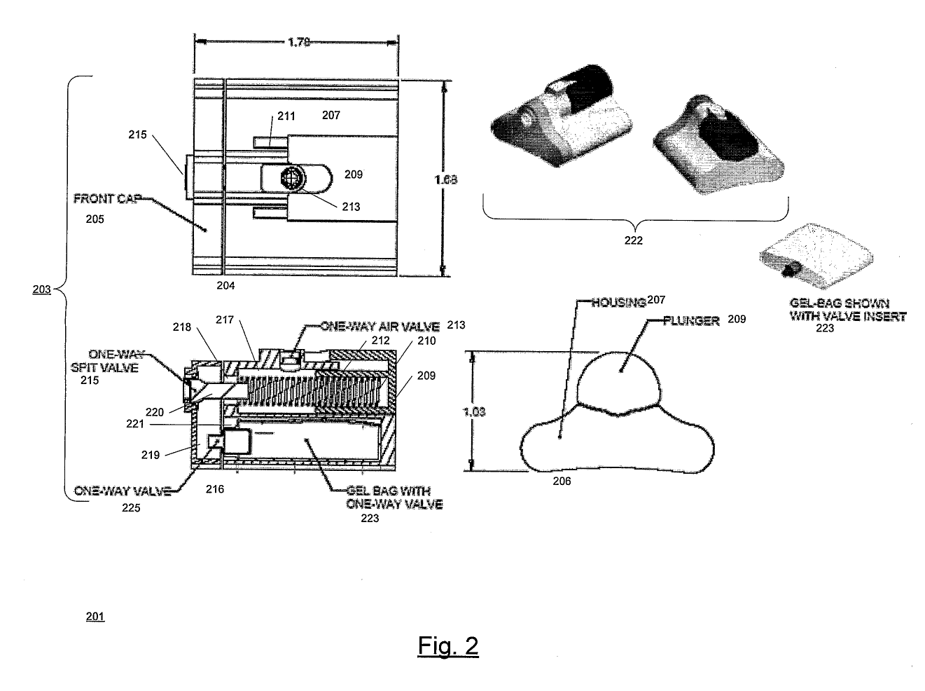

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

### Overview of the Invention

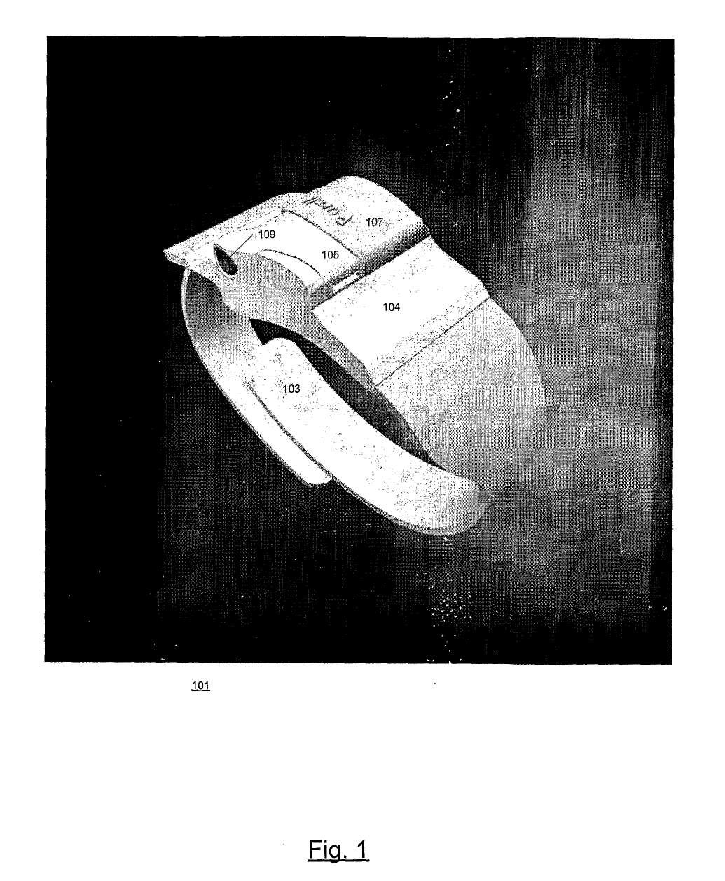

FIG. 1 provides an external view of a dispenser bracelet 101 that dispenses liquids or powders. Dispenser bracelet 101 includes a wrist band 103 so that it can be worn like a wrist watch. Mounted on wristband 103 is a dispenser 104 that contains a tank of the material (not shown), a pump 105, and a piston 107. Dispenser 104 is approximately the size of a large wristwatch. To activate the dispenser bracelet, the user presses piston 107 while wearing the bracelet. When the user does so, a small amount of the material being dispensed spurts from spit valve 109. The user wears bracelet 101 on the bottom side of his or her wrist with the spit valve facing the palm of the user's hand. When the user presses the piston with a finger of his or her other hand, the material is deposited on the palm or fingers of the hand whose wrist bears dispenser bracelet 101. The user can then spread the material as desired. Dispenser bracelet 101 can be either of a disposable or refillable type and can be a single compartment or a multiple compartment dispenser, storing different amounts and kinds of materials. Among the materials that can be dispensed using dispenser 101 are disinfectant hand cleaning liquids, suntan lotion, sun block, perfume, or insect repellant, to name just a few of the possibilities.

Different embodiments of bracelet 101 can dispense a material in a continuous stream or pre-defined fixed amount. The bracelet dispenses the material in response to pressure on an activator (here piston 107) from the user's finger. The activator may also be a push-sensitive trigger or a rotating wheel trigger. In a particularly simple embodiment of the invention, the dispenser portion of the bracelet may be a reservoir which is made of flexible plastic and has a nozzle that opens only when the pressure inside the reservoir is higher than the pressure outside. In such an embodiment, the activator is the wall of the reservoir and the user activates the dispenser simply by pressing on or squeezing the wall of the reservoir. In some embodiments, the wristband may be flexible enough to permit the user to aim the material by changing the position of dispenser 104 relative to the wristband. In other embodiments, a connection may be provided between the band and the dispenser which permits the user to aim the material. For example, the connection may permit the user to rotate the dispenser on the band.

### Details of Dispenser 104

### FIRST EMBODIMENT

### FIG. 2

FIG. 2 is a detailed drawing 201 of a first embodiment of dispenser 104. The main components of drawing 201 are views 203 of pump 105, including a detailed top view 204, a cutaway side view 216, and a rear view 206. Three-dimensional views of dispenser 104 are shown at 222. In these views, corresponding elements have the same reference numbers. In the preferred embodiment, dispenser 101 is of the disposable type. The material being dispensed is contained in a gel bag 223 in a compartment 221 in pump 105. In disposable embodiments of dispenser 101, the gel bag is placed in compartment 221 when dispenser 101 is manufactured; in refillable embodiments, a user may purchase a gel bag of the material separately and place it in compartment 221. In such an embodiment, access may be gained to compartment 221 by removing front cap 205.

Beginning with top view 204, the preferred embodiment of pump 105 has a front cap 205. Included in front cap 205 is a one-way spit valve 215. One-way spit valve 215 allows a blob of material to leave pump 105, but will not permit air to enter pump 105. Pump housing 207 includes a tube 217 in which a piston 209 moves and guide rails 211 for piston 209. A one-way air valve 213 permits air to enter tube 217 but not to leave tube 217. Piston 209 moves forward in tube 217 when pressed by a user of dispenser 101. It should be noted that portion 212 of piston 209 covers the opening of one-way air valve 213 during a portion of the travel of piston 209 in tube 217.

Continuing with side view 216, piston 209 works against spring 210. The user pushes piston 209 in against the spring and spring 210 pushes the piston back to its former position. Piston 209 works on both its back and forward strokes. On the back stroke, it sucks material from gel bag 223 and on the forward stroke, it forces the material out of pump 205 via nozzle 215. Operation of the pump involves in addition to piston 209 and tube 217, one way air valve 213, one way spit valve 215, one way valve 225, and chambers 219 and 221.
chamber 221 contains gel bag 223 and is always at the ambient air pressure;
An end of tube 217 and chamber 219 are interconnected by opening 218. Pressure in chamber 219 is determined by the motion of piston 209 in tube 217 and piston 209's interaction with one-way air valve 213.

The operational cycle of pump 105 is as follows:
1. The first stroke is a priming stroke. At the beginning of operation, piston 209 is in its back position in tube 217, chamber 219 is at atmospheric pressure, and the level of the material being dispensed is below one way spit valve 215 in chamber 219. When the user pushes piston 209 forward in tube 217, the air pressure in chamber 219 rises and the pressure forces open one way spit valve 215.
2. At the end of the forward stroke, spring 210 forces piston 209 back. There are two parts of the back stroke: a first part in which one way air valve 213 is covered by portion 212 of piston 209 and a second part in which one way air valve 213 is not covered by portion 212.
   a) Because air valve 213 is covered during the first part of the back stroke, a vacuum develops in chamber 219. In response to the vacuum, one-way spit valve 215 remains closed and the ambient air pressure of chamber 221 works on gel bag 223 to force the contents of the material out into chamber 219. The dimensions of tube 217 and chamber 219 and the location of one-way air valve 213 in tube 217 are chosen such that the amount of material forced out fills most of chamber 219.
   b) During the second part, one way air valve 213 is uncovered, so that tube 217 fills with air at atmospheric pressure.
3. On the next forward stroke, one way air valve 213 prevents the air in chamber 217 from leaving the chamber, so the compressed air finds its way via opening 218 into chamber 219, where it forces the material which was drawn into the chamber during the first part of the preceding back stroke out of one-way spit valve 215. The amount of material forced out depends on the size of chamber 217, the location of one way spit valve 215 in the chamber, and the length of the stroke of the piston after the one-way valve.

On the next back stroke, chamber 219 will again fill with the material and tube 217 with air as just described, and the cycle will continue.

One way valves 213 and 225 are standard items in the relevant technologies. The one-way spit valve 215 is an adaptation of the anti-drip valves used on catsup bottles. These anti-drip valves are silicon membranes which contain a slit that opens when the membrane bulges in response to a pressure difference on its two sides and closes again when the pressure difference ends. Because the anti-drip valve closes automatically, the catsup leaves the bottle in a burst, instead of dribbling out. For the same reason, when the material is forced out of chamber 219, it comes out in a burst, instead of dribbling out.

The problem with using an anti-drip valve like the ones on catsup bottles for spit valve 215 is that when the air pressure in the catsup bottle is less than the atmospheric pressure, the anti-drip valve also opens to permit air to enter the catsup bottle. While this is desirable in catsup bottles, one-way spit valve 215 must not open when there is a vacuum in chamber 219. The one way action of valve 215 is achieved by means of support 220, which prevents spit valve 221 from bulging and therefore opening to admit air when there is a vacuum in chamber 219 but does not completely block the contents of chamber 219 from reaching spit valve 215. Thus, when the pressure in chamber 215 is higher than atmospheric pressure, air or material contained in chamber 219 can exit via one way spit valve 215, but when there is a vacuum in chamber 219, the one way spit valve remains sealed.

### SECOND EMBODIMENT

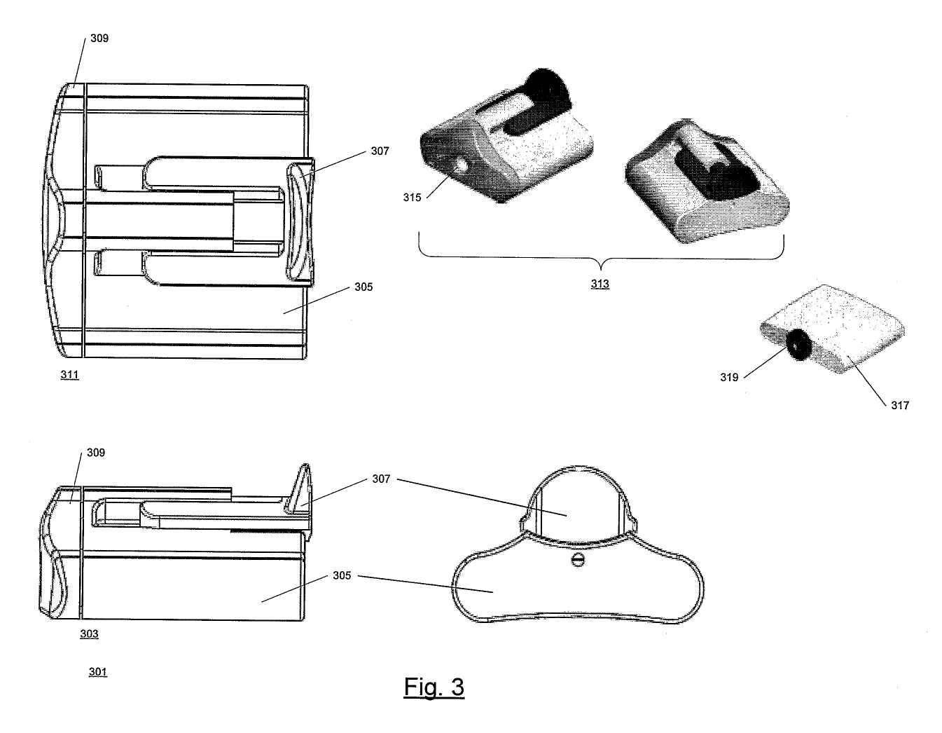

### FIGS. 3-5

FIG. 3 shows various views of a second embodiment 301 of dispenser 104. Dispenser 301 operates according to the same general principles as first embodiment 201. At 303 is shown a side view, at 311 is shown a top view, and at 313 is shown an end view. Three-dimensional views from the front and rear are shown at 313; gel bag 317 containing the material to be dispensed has one-way valve 319. Components of dispenser 301 that are of interest in the present context are housing 305, front cap 309, piston 307, and nozzle 315. In dispenser 301, front cap 309 is removable, permitting replacement of gel bag 317.

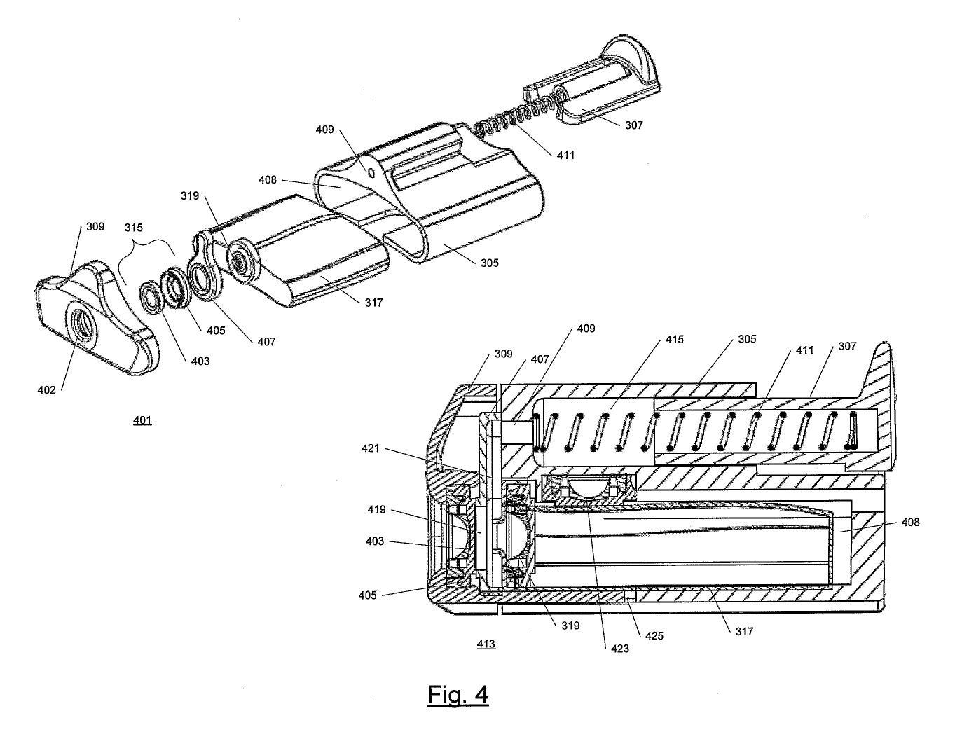

FIG. 4 shows an exploded view 401 and a cross-sectional view 413 of dispenser 301. Beginning at the left of exploded view 401 there are seen front cap 309 with a hole 402 for nozzle 315, and nozzle 315, which has two components: spit valve 403 with support 405 which prevents spit valve 403 from flexing to the right. Material chamber 407 is connected by a passage to the tube in which piston 307 moves and has a cavity which fills with material from gel bag 317 when piston 307 moves back. Then come gel bag 317 with one-way valve 319, housing 305 with chamber 408 for gel bag 317 and hole 409 belonging to the passage connecting the tube with material chamber 407, spring 411 for piston 307, and finally the piston itself.

Cross-sectional view 401 additionally shows cavity 419 in material chamber 407 and passage 421 which connects cavity 419 to hole 409. Hole 409 is in turn connected to tube 415 in which piston 307 moves. One-way valve 423 connects tube 415 to chamber 408 for gel bag 317. A passage 425 ensures that chamber 408 remains at atmospheric pressure. Dispenser 301 operates in exactly the same fashion as dispenser 201. Advantages of dispenser 301 include the following:
1. The location of one-way air valve 423 so that it opens onto cavity 408 reduces the overall height of dispenser 301 and protects air valve 423;
2. Material Chamber 419 has been designed to minimize the formation of pockets of air in the material that is drawn into chamber 419 from gel bag 317. Such pockets keep the blast of air produced when the piston is moved towards the end of tube 415 from pushing out all of the material in chamber 419. Maximizing the force of the air blast is particularly important with higher-viscosity materials.
3. The spit valve has been relocated so that it is in line with the nozzle 318 of the gel bag. The new location also prevents pockets of air from forming in the material in chamber 419.

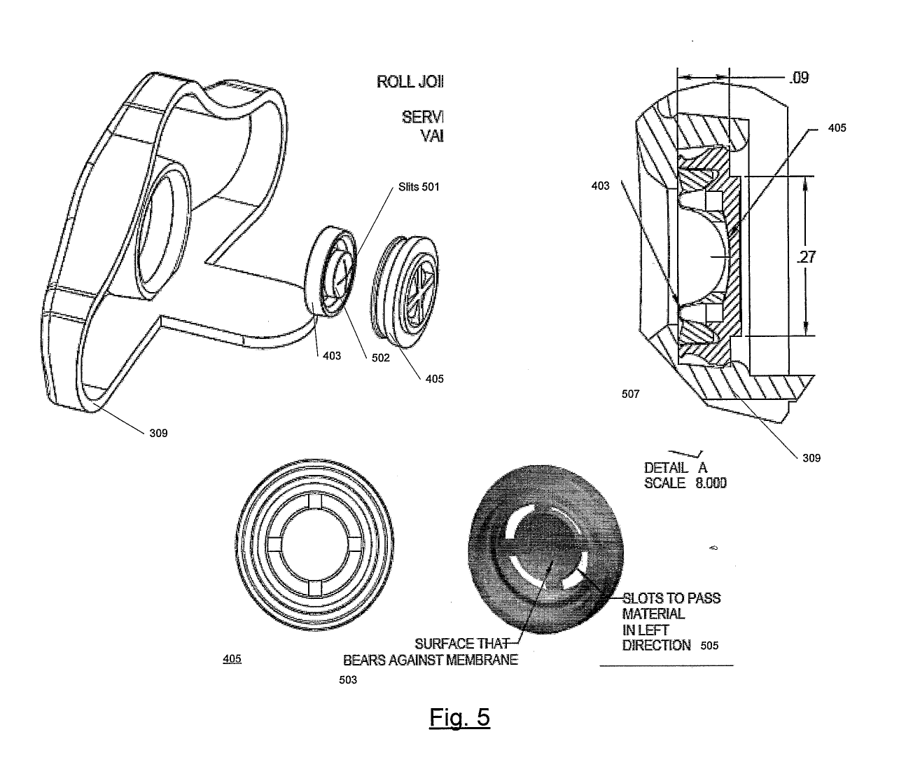

### Details of One-Way Spit Valve 315: FIG. 5

One-way Spit valve 315 incorporates a silicon valve 403 of a type that is manufactured under the name SimpliSqueeze® by Seaquist Closures, 711 Fox St., Mukwonago, Wis. 53149. As shown at 403 in FIG. 5, valve 403 is a silicon diaphragm 502 with slits 501. When a pressure difference between the sides of diaphragm 502 causes diaphragm 502 to bulge towards the side with lower pressure, the flaps defined by the slits 501 roll back and material can pass through the part of the diaphragm between the slits. Silicon valves like valve 403 are typically used in applications like catsup bottles. When the catsup bottle is squeezed, the valve bulges outward and opens, a blob of catsup comes out, the valve ceases to bulge out and closes, and then bulges in and opens again to admit air to the catsup bottle. Once the pressure on both sides of the valve is equal, the valve ceases bulging and closes.

When silicon valve 403 is used in one-way spit valve 315, it must bulge out and open when the pressure in chamber 419 is greater than the atmospheric pressure, but remain closed when the pressure in chamber 419 is less than atmospheric pressure. The valve will remain closed if it is not permitted to bulge in when the pressure in chamber 419 is less than atmospheric pressure. To prevent valve 403 from bulging in, a preferred embodiment employs support 405. Support 405 has slots 505 to permit the material in chamber 419 to pass through support 405 when valve 403 is open and surface 503 that bears against diaphragm 402 and prevents valve 403 from bulging in and opening when chamber 419 is at less than atmospheric pressure. At 507 is shown a detailed cross section of front cap 309 with components 403 and 405 of one-way spit valve 315 installed in it.

### CONCLUSION

The foregoing Detailed Description has disclosed to those skilled in the relevant technologies how to make and use apparatus for dispensing material that includes a bracelet and a dispenser as well as a pump and a one-way valve employed in a preferred embodiment of the dispenser and has further disclosed the best mode known to the inventors of making and using the apparatus for dispensing material, the pump, and the one-way valve. It will, however, be immediately apparent to those skilled in the relevant technologies that apparatus for dispensing material, pumps, or one-way valves that operate according to the principles disclosed herein may be made that differ in many ways from the preferred embodiments disclosed herein. For example, the dispenser may use any available technique for transferring the material from the dispenser's reservoir to the user's palm when the user presses the activator, the material may be any material which can be usefully dispensed in that fashion, and the bracelet can be made in any fashion which suits the purpose. Pumps made according to the principles of the pump disclosed herein may be of any size and may have many different arrangements of their components relative to each other. Similarly, the diaphragm of the one-way valve disclosed herein may be made of any material which has the necessary properties as regards flexing and opening when it is flexed and the support may be implemented in any way which permits the diaphragm to flex in one direction and prevents the diaphragm from flexing in the other. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. (canceled)

2. (canceled)

3. (canceled)

4. (canceled)

5. (canceled)

6. The apparatus for dispensing material set forth in claim 32 wherein:
the source may be refilled with the material.

7. The apparatus for dispensing material set forth in claim 6 wherein:
the material is contained in a container; and
the source is refilled by placing the container in the space.

8. The apparatus set forth in any one of claims 32 wherein:
the material is a liquid.

9. The apparatus set forth in any one of claims 32 wherein:
the material is a powder.

10. The apparatus set forth in any one of claims 32 wherein:
the material has germicidal properties.

11. The apparatus set forth in any one of claims 32 wherein:
the material has properties which protect the skin against solar radiation.

13. The apparatus set forth in claim 32 wherein:
operation of the pump is not affected by the orientation of the dispenser.

14. The apparatus set forth in any one of claims 32 wherein:
the dispenser is approximately the size of the watch in a wristwatch.

15. The apparatus set forth in any one of claims 32 wherein:
the bracelet may additionally be used in any way in which a bracelet has been or will be used.

16. (canceled)

17. The apparatus set forth in claim 33 wherein:
the size of the portion of material that moves from the source into the chamber depends on the travel of the piston in the tube.

18. (canceled)

19. The apparatus set forth in claim 33 wherein:
the actuator includes a spring which urges the piston away from the end of the tube to a start position.

20. The apparatus set forth in claim 33 wherein:
the spring is located inside the tube.

21. (canceled)

22. (canceled)

23. The apparatus set forth in claim 33 wherein the first one-way valve comprises:
a flexible diaphragm having an opening which is closed when the diaphragm is flat and which opens increasingly as the diaphragm flexes in response to a difference between the pressure inside the chamber and the pressure outside the chamber; and
a support which permits the diaphragm to flex when the pressure inside the chamber is higher than the pressure outside the chamber but prevents the diaphragm from flexing when the pressure outside the chamber is higher than the pressure inside the chamber.

24. The pump set forth in claim 23 wherein:
the support further permits passage of the material from the chamber through the flexed diaphragm.

25. (canceled)

26. (canceled)

27. (canceled)

28. (canceled)

29. (canceled)

30. (canceled)

31. (canceled)

32. Apparatus for dispensing material comprising:
a bracelet; and
a dispenser for the material attached to the bracelet,
the dispenser including
a source for the material;
a chamber coupled to the source for the material;
a nozzle coupled to the chamber; and
a pump coupled to chamber, the pump having an actuator and operating in response to the actuator to produce a vacuum in the chamber which causes material from the source to enter the chamber and to expel the material in the chamber through the nozzle,
the apparatus being characterized in that:
when a user is using the apparatus to dispense material, the bracelet is on the user's wrist, the dispenser is on the palm side of the wrist, the nozzle directs the material towards the user's palm, and the actuator is on a side of the dispenser which is opposite the user's palm

33. The apparatus set forth in claim 32 wherein the pump comprises:
a piston that moves in a tube, the actuator operating to move the piston in the tube and the tube having an end coupled to the chamber,
a first one-way valve located between the chamber and the nozzle, and
a second one-way valve located between the source and the chamber,
the second one-way valve opening when the pressure in the chamber is lower than the pressure on the material in the source and the first one-way valve opening when the pressure in the chamber is higher than the pressure on the other side of the first one-way valve,
the pump operating when the actuator moves the piston away from the end of the tube to lower the pressure in the chamber and thereby cause a portion of the material to move from the source through the second one-way valve into the chamber and when the actuator moves the piston back toward the end of the tube to raise the pressure in the chamber and thereby to cause material in the chamber to move through the first one-way valve.
